(19) United States
(12) Patent Application Publication
(10) Pub. No.: US 2010/0170447 A1
(43) Pub. Date: Jul. 8, 2010

(54) PEST DETERRENT PET BOWL

(76) Inventor: Stephen A. Pridgen, JR., Greenwood, MS (US)

Correspondence Address: LUEDEKA, NEELY & GRAHAM, P.C., P O BOX 1871, KNOXVILLE, TN, 37901, US

(21) Appl. No.: 12/619,990

(22) Filed: Nov. 17, 2009

Related U.S. Application Data
(60) Provisional application No. 61/142,761, filed on Jan. 6, 2009.

(51) Int. Cl. A01K 29/00

(52) U.S. Cl. 119/61.53; 119/61.57

(57) ABSTRACT

An animal feeder is disclosed for preventing pests from accessing food contents of the animal feeder. The animal feeder includes an upper bowl for receiving food contents and a lower bowl disposed below the upper bowl so that a cavity is provided between the upper bowl and lower bowl for receiving a pest deterrent. The cavity and pest deterrent prevents pests from crawling from the lower bowl to the upper bowl to access the food contents of the upper bowl. An attachment assembly is provided for connecting the upper bowl to the lower bowl. The attachment assembly includes a first threaded fastener attached to a first supporting flange and a second threaded fastener attached to a second supporting flange. The first supporting flange is attached to the lower bowl and the second supporting flange is attached to the upper bowl. A center support post connects the lower and upper bowl by receiving the first threaded fastener in a first threaded hole on a first end of the center support post and receiving the second threaded fastener in a second threaded hole on a second end of the center support post.

### CROSS-REFERENCE TO RELATED APPLICATION

This application claims priority to provisional application No. 61/142,761 filed Jan. 6, 2009 titled Dog Bowl, the entire contents being incorporated herein by reference.

### FIELD

This invention relates generally to a pet bowl or animal feeder. More specifically, this invention relates to an animal feeder having an upper bowl attached to a lower bowl for providing a cavity between the bowls for preventing pests from accessing food contents of the animal feeder.

### BACKGROUND

There are numerous commercially available animal feeders that come in varying sizes, shapes, and materials. The most common are in the shape of a bowl shaped to receive and hold food contents. In order to restrict pests from accessing the food contents of the bowls, various types of animal feeders have been disclosed that utilize a moat arrangement surrounding the food bowl portion of the animal feeder. However, the animal feeders having a moat arrangement as previously disclosed require custom tooling and fabrication. In other words, the animal feeders previously disclosed require specially manufactured bowls (e.g. specialty stampings, moldings, machining, etc.) in order to create the moat arrangement, which can be extremely expensive to produce and bring to market.

Other disadvantages of the animal feeders previously disclosed include the ineffective attachments between the upper and lower bowls of the animal feeders having a two-tiered system. Problems with the attachments between the upper and lower bowls include the ease in which the bowls are removeably attached and the amount of support the attachment assemblies receive from the surfaces of the bowls.

Accordingly, it is desirable to provide an animal feeder that prevents pests from accessing the food contents of the bowl. Further, it is desirable to provide an animal feeder that deters pests that can be easily constructed from off-the-shelf dog bowls that are already commercially available.

### SUMMARY

Embodiments of the invention described herein pertain to an animal feeder for preventing pests from accessing food contents of the animal feeder. The animal feeder includes an upper bowl having a recess for receiving food contents and a lower bowl disposed below the upper bowl so that a cavity is provided between the upper bowl and lower bowl for receiving a pest deterrent. An attachment assembly is provided for connecting the upper bowl to the lower bowl. The attachment assembly includes a first threaded fastener attached to an inside surface of the lower bowl so that the first threaded fastener extends towards the upper bowl, a second threaded fastener attached to a bottom surface of the upper bowl so that the second threaded fastener extends towards the lower bowl, and a center support post having a first threaded hole on a first end of the center support post for receiving the first threaded fastener and a second threaded hole on a second end of the center support post for receiving the second threaded fastener.

In preferred embodiments, the attachment assembly includes a first supporting flange disposed between the inner surface of the lower bowl and the first threaded fastener and a second supporting flange disposed between the bottom surface of the upper bowl and the second threaded fastener. The first and second threaded fasteners are attached to the first and second supporting flanges by welding and the first and second supporting flanges are attached to the lower and upper bowls using epoxy. In other embodiments, the attachment assembly may include only one of the first and second supporting flanges.

In other embodiments, the lower and upper bowl are commercially available off-the-shelf pet bowls. Further, the upper bowl includes a topmost perimeter and the lower bowl includes a top perimeter, and the topmost perimeter of the upper bowl has at least a substantially equal length diameter as the top perimeter of the lower bowl. The topmost perimeter of the upper bowl may also includes a rim that extends remote from the top perimeter of the lower bowl for permitting access to the cavity between the lower and upper bowls.

### BRIEF DESCRIPTION OF THE DRAWINGS

Further advantages of the invention are apparent by reference to the detailed description in conjunction with the figures.

FIG. 1 depicts a perspective view of an animal feeder according to an embodiment of the present invention;

FIG. 2 depicts a front cross-sectional view of an animal feeder before attachment of upper and lower bowls according to an embodiment of the present invention;

FIG. 3 depicts a front cross-sectional view of an animal feeder after attachment of the upper and lower bowls according to an embodiment of the present invention;

FIG. 4 depicts a front cross-sectional view of an animal feeder before attachment of the upper and lower bowls and including first and second supporting flanges according to an embodiment of the present invention; and

FIG. 5 depicts a front cross-sectional view of an animal feeder after attachment of the upper and lower bowls and including first and second supporting flanges according to an embodiment of the present invention.

### DETAILED DESCRIPTION

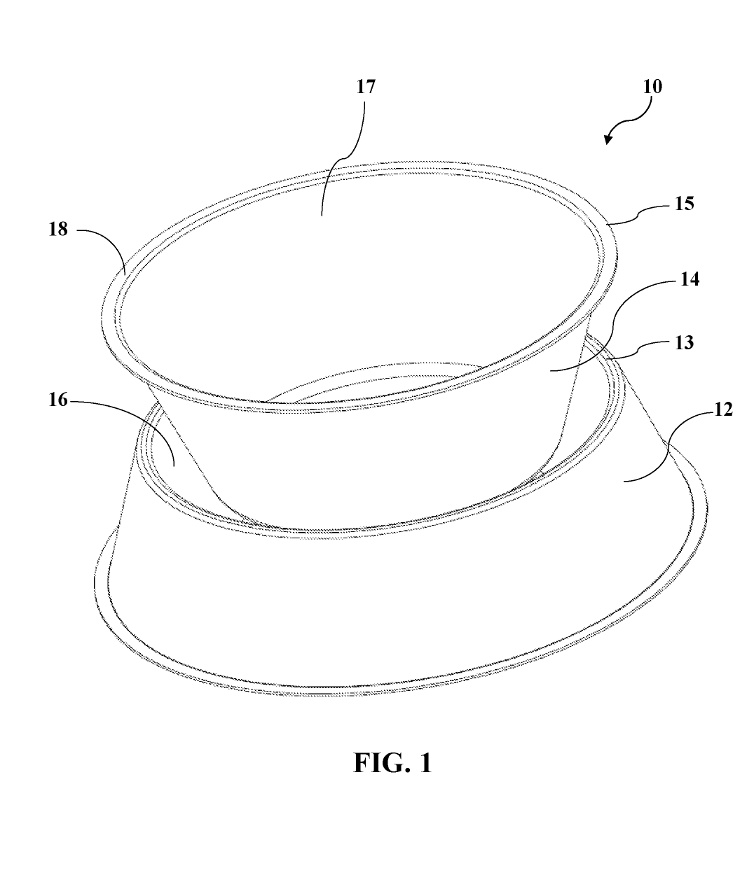

Referring to FIG. 1, a pet bowl or animal feeder 10 is shown having a lower bowl 12 disposed below an upper bowl 14 having a recess 17 for receiving food contents. The lower bowl 12 and upper bowl 14 are connected so that a moat or cavity 16 is provided between the lower bowl 12 and upper bowl 14 for preventing crawling pests from accessing the food contents of the upper bowl 14. The cavity 16 may be filled with a pest deterrent such as water, pesticide for killing the pests, or some other type of sticky substance that entraps the crawling pests. In preferred embodiments, the pest deterrent is water because it will not harm the pet if ingested, is inexpensive, and is easy to replace and clean.

In preferred embodiments, the lower and upper bowl 12 and 14 are constructed of stainless steel and are of the off-the-shelf type pet bowls found in most pet supply stores. While specially fabricated bowls may be used in constructing embodiments of the invention, the animal feeder 10 of preferred embodiments does not require special bowls needing to be custom manufactured. Thus, commercially available off-the-shelf type pet bowls may be used. The size of the off-the-shelf lower and upper bowls 12 and 14 are preferably two quarts and one quart, respectively. However, the animal feeder 10 should not be limited to bowls of these sizes and other sized bowls may be used.

As shown in FIG. 1, the upper bowl 14 includes a topmost perimeter 15 and the lower bowl 12 includes a top perimeter 13. In preferred embodiments, the topmost perimeter 15 of the upper bowl 14 has at least a substantially (i.e. close to) equal length diameter as the top perimeter 13 of the lower bowl 12. Thus, the diameter of the topmost perimeter 15 of the upper bowl 14 is large enough to prevent food contents of the upper bowl 14 from dropping into the cavity 16 holding the pest deterrent. The topmost perimeter 15 of the upper bowl 14 also includes a rim 18 that may or may not extend downward towards the top perimeter 13 of the lower bowl 12. If the rim 18 does extend downward, it preferably extends to a distance that is still remote from the top perimeter 13 of the lower bowl 12. Thus, the rim 18 of the upper bowl 14, or lack thereof, does not prevent access to the cavity 16 of the animal feeder 10 so that the cavity 16 may be cleaned easily by, for example, using high pressure water. In this embodiment, water should be used as the pest deterrent as the animal or pet would have access to the cavity 16 and the animal would not be harmed by consuming the water.

In other embodiments of the invention, the rim 18 of the upper bowl 14 may extend beyond or adjacent to the top perimeter 13 of the lower bowl 12 to act as a barrier for the cavity 16. In these embodiments, pesticides may be used as the pest deterrent because the rim 18 prevents the animal from accessing the cavity 16 and fumes from the pesticides from being inhaled by the animal.

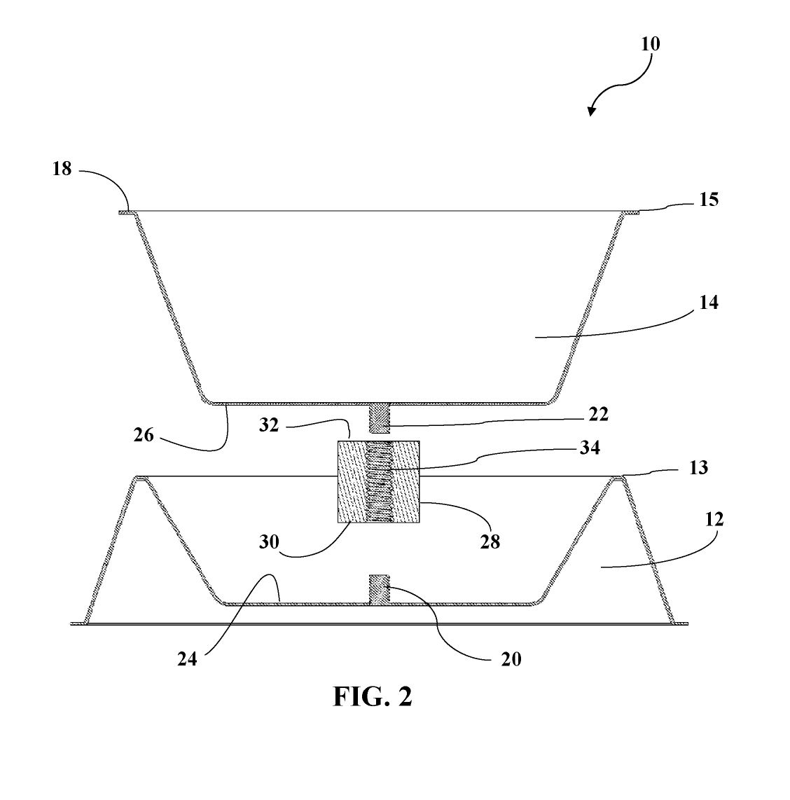

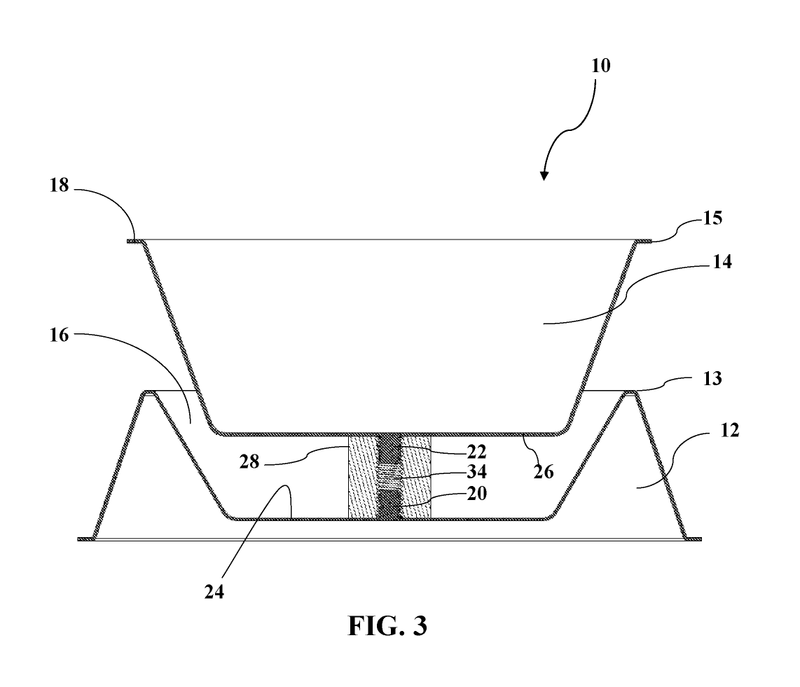

As depicted in FIGS. 2-5, the animal feeder 10 includes an attachment assembly for connecting the upper bowl 14 to the lower bowl 12. Referring to FIGS. 2-3, the attachment assembly includes a first threaded fastener 20 attached to an inside surface 24 of the lower bowl 12 and a second threaded fastener 22 attached to a lower surface 26 of the upper bowl 14. A center support post 28 having a threaded center hole 30 is provided for receiving the first and second threaded fasteners 20 and 22 to removeably attach the upper bowl 14 to the lower bowl 12.

In preferred embodiments, the first and second threaded fasteners 20 and 22 are copper coated mild steel threaded studs, but other types of fasteners may be used such as stainless steel. The size and length of the first and second threaded fasteners 20 and 22 are not critical, but current embodiments of animal feeders 10 use 5/16″×18½″ fasteners. To attach the first and second threaded fasteners 20 and 22 to the surfaces of their respective bowls 12 and 14, the fasteners are preferably welded for a more secure attachment. However, other types of attachments are possible such as using epoxy to glue the fasteners to the surfaces.

The center support post 28 is preferably made of aluminum, but it could be made of any material that is typically not corrosive when in contact with water. While many types of center support posts 28 may be used to connect the first and second threaded fasteners 20 and 22 as known in the art, the center support post 28 in preferred embodiments of the invention includes a counter sunk mating threaded center hole 34 on the lower end 30 and upper end 32 of the post 28, or throughout the entire post 28 as depicted in FIGS. 2-5. The center support post of preferred embodiments is made of extruded aluminum having a center hole 34 of a desirable size. Once the aluminum is cut to the desired length, a counter bore is made at the lower and upper end 30 and 32 of the post about the center hole 34. The counter bore is used to provide clearance for the bases of the fasteners 20 and 22. The center hole 34 is then tapped according to the desired mating size for the fasteners 20 and 22.

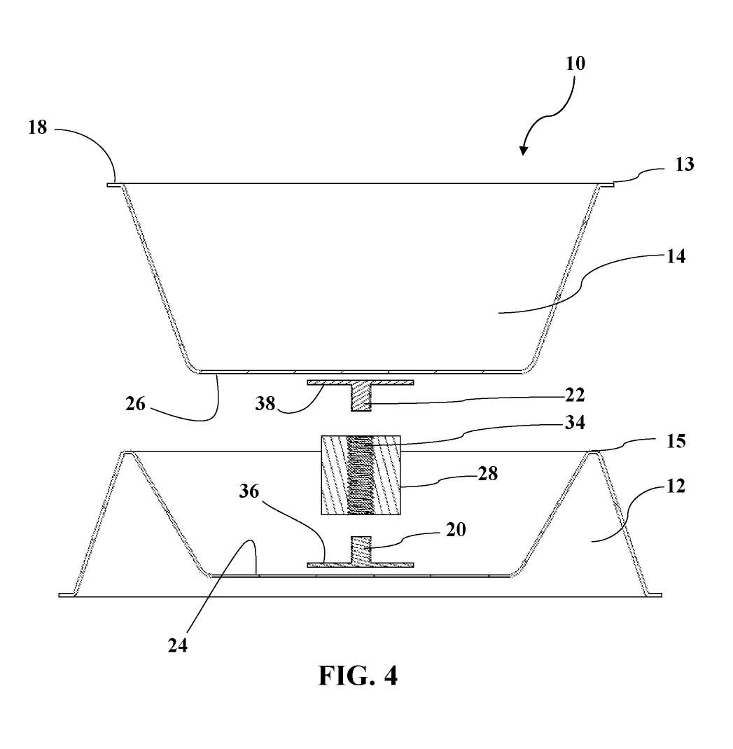

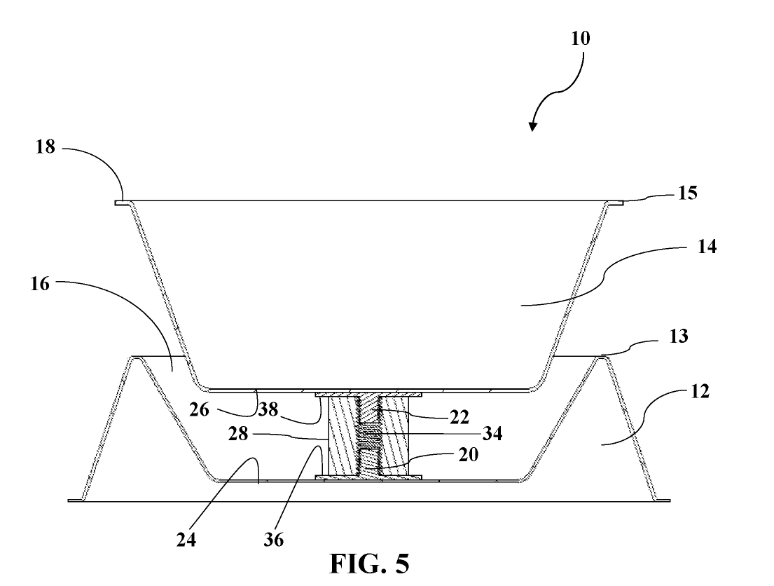

Referring to FIGS. 4-5, in another embodiment of the invention, the first threaded fastener 20 is attached to a first supporting flange 36 and the second threaded fastener 22 is attached to a second supporting flange 38. The first and second supporting flanges 36 and 38 are provided for additional support in attaching the first and second threaded fasteners 20 and 22 to the lower and upper bowls 12 and 14. As most off-the-shelf type pet bowls do not have enough thickness in their inner surfaces 24 and lower surfaces 26 to adequately weld the threaded fasteners 20 and 22 to the lower and upper bowls 12 and 14, the first and second supporting flanges 36 and 38 provide the needed extra support. In this embodiment, the first and second threaded fasteners 20 and 22 are preferably welded to their respective first and second supporting flanges 36 and 38, and then the first and second supporting flanges are attached to the pet bowls 12 and 14 using epoxy, by welding, or other known attachment means.

In preferred embodiments, the first and second supporting flanges 36 and 38 are stainless steel to match the preferred construction of the lower and upper bowls 12 and 14. However, other materials may be used such as plastic to provide the needed extra support to attach the first and second threaded fasteners.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention.

What is claimed is:

1. An animal feeder for preventing pests from accessing food contents of the animal feeder, the animal feeder comprising:
an upper bowl having a recess for receiving food contents;
a lower bowl disposed below the upper bowl so that a cavity is provided between the upper bowl and lower bowl for receiving a pest deterrent, the cavity and pest deterrent for preventing pests from crawling from the lower bowl to the upper bowl; and
an attachment assembly for connecting the upper bowl to the lower bowl, the attachment assembly comprising:
a first threaded fastener attached to an inside surface of the lower bowl and extending towards the upper bowl;
a second threaded fastener attached to a bottom surface of the upper bowl and extending towards the lower bowl; and
a center support post having a first threaded hole on a first end of the center support post for receiving the first threaded fastener and second threaded hole on a second end of the center support post for receiving the second threaded fastener.

2. The animal feeder of claim 1 wherein the attachment assembly further comprises a first supporting flange disposed between the inner surface of the lower bowl and the first threaded fastener.

3. The animal feeder of claim 1 wherein the attachment assembly further comprises a first supporting flange disposed between the bottom surface of the upper bowl and the second threaded fastener.

4. The animal feeder of claim 1 wherein the attachment assembly further comprises:
a first supporting flange disposed between the inner surface of the lower bowl and the first threaded fastener; and
a second supporting flange disposed between the bottom surface of the upper bowl and the second threaded fastener.

5. The animal feeder of claim 4 wherein the first threaded fastener is attached to the first supporting flange and the second threaded fastener is attached to the second supporting flange by welding.

6. The animal feeder of claim 5 wherein the first supporting flange is attached to the lower bowl and the second supporting flange is attached to the upper bowl using epoxy.

7. The animal feeder of claim 1 wherein the lower bowl and upper bowl are commercially available off-the-shelf pet bowls.

8. The animal feeder of claim 1 wherein the upper bowl includes a topmost perimeter and the lower bowl includes a top perimeter, the topmost perimeter of the upper bowl having at least a substantially equal length diameter as the top perimeter of the lower bowl.

9. The animal feeder of claim 1 wherein the upper bowl includes a topmost perimeter having a rim and the lower bowl includes a top perimeter, the rim of the upper bowl extending remote from the top perimeter of the lower bowl for permitting access to the cavity between the lower and upper bowls.

10. The animal feeder of claim 1 wherein the center support post is extruded aluminum.

11. An animal feeder attachment assembly for connecting an upper bowl to a lower bowl, the attachment assembly comprising:
a first supporting flange having a first threaded fastener welded to the first supporting flange, the first supporting flange for attaching to an inside surface of the lower bowl so that the first supporting flange is disposed between the inside surface of the lower bowl and the first threaded fastener;
a second supporting flange having a second threaded fastener welded to the second supporting flange, the second supporting flange for attaching to a bottom surface of the upper bowl so that the second supporting flange is disposed between the bottom surface of the upper bowl and the second threaded fastener; and
a center support post having a first threaded hole on a first end of the center support post for receiving the first threaded fastener and second threaded hole on a second end of the center support post for receiving the second threaded fastener,
wherein the connecting of the upper bowl to the lower bowl with the attachment assembly provides a cavity between the upper bowl and lower bowl for receiving a pest deterrent and preventing pests from crawling from the lower bowl to the upper bowl.

12. The attachment assembly of claim 11 further comprising epoxy for attaching the first supporting flange to the inside surface of the lower bowl and the second supporting flange to the bottom surface of the upper bowl.

13. The attachment assembly of claim 11 wherein the center support post is extruded aluminum.

14. An animal feeder for preventing pests from accessing food contents of the animal feeder, the animal feeder comprising:
an upper bowl having a recess for receiving food contents and a topmost perimeter having a rim;
a lower bowl disposed below the upper bowl so that a cavity is provided between the upper bowl and lower bowl for receiving a pest deterrent, the cavity and pest deterrent for preventing pests from crawling from the lower bowl to the upper bowl, the lower bowl including a top perimeter wherein the rim of the upper bowl extends remote from the top perimeter of the lower bowl for permitting access to the cavity between the lower and upper bowls; and
an attachment assembly for connecting the upper bowl to the lower bowl, the attachment assembly comprising:
a first supporting flange having a first threaded fastener welded to the first supporting flange, the first supporting flange for attaching to an inside surface of the lower bowl so that the first threaded fastener extends towards the upper bowl;
a second supporting flange having a second threaded fastener welded to the second supporting flange, the second supporting flange for attaching to a bottom surface of the upper bowl so that the second threaded fastener extends towards the lower bowl; and
a center support post having a first threaded hole on a first end of the center support post for receiving the first threaded fastener and second threaded hole on a second end of the center support post for receiving the second threaded fastener.

15. The animal feeder of claim 14 wherein the first supporting flange and second supporting flange are attached to the lower bowl and upper bowl using epoxy.

16. The animal feeder of claim 14 wherein the lower bowl and upper bowl are commercially available off-the-shelf pet bowls.

17. The animal feeder of claim 14 wherein the topmost perimeter of the upper bowl includes at least a substantially equal length diameter as the top perimeter of the lower bowl.

18. The attachment assembly of claim 14 wherein the center support post is extruded aluminum.
